(19) United States
(12) Patent Application Publication
(10) Pub. No.: US 2024/0217611 A1
(43) Pub. Date: Jul. 4, 2024

(54) An electric or hybrid rideable saddle vehicle comprising a rechargeable battery and a storage container

(71) Applicant: PIAGGIO & C. SPA, Pontedera (IT)

(72) Inventors: Emiliano GUIDI, Pontedera (IT); Niccolò CUTRI’, Pontedera (IT)

(21) Appl. No.: 18/289,011

(22) PCT Filed: Apr. 14, 2022
(86) PCT No.: PCT/IB2022/053519

§ 371 Date: Oct. 31, 2023

(30) Foreign Application Priority Data
May 5, 2021 (IT) 102021000011438

(51) Int. Cl. B62K 19/46; B62J 9/14; B62J 43/16; B62J 43/28

(52) U.S. Cl. CPC B62K 19/46; B62J 9/14; B62J 43/16; B62J 43/28

(57) ABSTRACT

An electric or hybrid rideable saddle vehicle, including a rechargeable battery which extends between a bottom portion and a head portion, an electric or hybrid traction motor which can be supplied by the rechargeable battery to deliver a traction torque, a storage container, where the storage container includes a first housing seat which at least partially houses the rechargeable battery so that the rechargeable battery can be inserted into, and removed from, the first housing seat, a second housing seat adapted and configured to house at least one helmet, having a first portion and a second portion, wherein: the second portion is arranged below the first portion and adjacent to the first housing seat, and when the rechargeable battery is inserted into the first housing seat, the head portion of the rechargeable battery partially occupies the second housing seat, leaving the first portion partially free and the second portion totally free.

### TECHNICAL FIELD OF THE INVENTION

The present invention relates to the technical field of rideable saddle vehicles, and particularly relates to an electric or hybrid rideable saddle vehicle comprising a rechargeable battery and a storage container. The present patent application claims the priority of Italian Patent Application No. 102021000011438 dated May 5, 2021, entirely incorporated herein by reference.

### BACKGROUND OF THE INVENTION

As is known, some types of rideable saddle vehicles, such as motorcycles, for example, in particular but not only motor scooters with two or more wheels, comprise one or more storage containers. Generally, these containers have a housing seat which allows housing at least one safety helmet, for example when the scooter is in a parking state. While driving the motorcycle, when the driver is wearing a safety helmet, the housing seat allows housing a second safety helmet, for example for possible use by a passenger. For example, storage containers integrated in the scooter body and arranged below the saddle are known. Here, the saddle is a closing element of the storage container and may selectively take an opening configuration for allowing access to the housing seat and a closing configuration for preventing access to the housing seat.

With the introduction of electric or hybrid rideable saddle vehicles, the need has arisen to accommodate one or more rechargeable batteries onboard such vehicles. The rechargeable battery provides the electrical power required to supply the traction motor so that it delivers a drive torque. As is known, in order to ensure satisfactory autonomy or power, the rechargeable batteries usually are cumbersome. In some cases, it was considered to accommodate one or more rechargeable batteries in spaces which previously could have been utilized for accommodating one or more helmets. In these cases, the vehicles have the drawback of losing useful space which could have been employed for accommodating one or more helmets. EP 1108644 A2 describes an example for the arrangement of the battery for a two-wheel vehicle, in which the battery is arranged at the front with respect to a storage container adapted to contain a helmet. The suggested arrangement is not compatible with batteries having the performance usually required in electric or hybrid rideable saddle vehicles because, in order to ensure such performance, such batteries are relatively much more cumbersome. Therefore, the solution suggested in EP 1108644 A2 does not solve the above-described drawback in this type of vehicles.

It is a general object of the present description to provide an electric or hybrid rideable saddle vehicle with a storage container which is capable of completely or at least partially overcoming the aforesaid drawback.

Such an object is achieved by a rideable saddle vehicle, as generally defined in claim 1. Preferred and advantageous embodiments of the aforesaid vehicle are defined in the appended dependent claims.

The invention will be better understood from the following detailed description of particular embodiments thereof, given by way of non-limiting example, with reference to the accompanying drawings briefly described in the following paragraph.

### BRIEF DESCRIPTION OF THE DRAWINGS

In the accompanying drawings:

FIG. 1 shows a side plan view of a non-limiting embodiment of a rideable saddle vehicle comprising a storage container integrated in the body of the rideable saddle vehicle;

FIG. 2 shows a diagrammatic sectional view of a part of the vehicle in FIG. 1, in which a non-limiting embodiment of the storage container is shown;

FIG. 3 shows a diagrammatic view of a possible internal subdivision of the storage container in a plurality of housing seats;

FIG. 4 shows an axonometric view of a part of the vehicle in FIG. 1 in which the storage container is shown in an opening configuration which shows the inside of the container and a locking device arranged inside the container, in which the locking device is shown in a locking position;

FIG. 5 shows an axonometric view similar to that shown in FIG. 4, in which the locking device is shown in a releasing position;

FIG. 6 is a partial perspective view of the vehicle in FIG. 1, with parts sectioned so as to show the inside of the storage container when the container is in the closing configuration.

### DETAILED DESCRIPTION

The same or similar elements are indicated by the same reference signs in the accompanying drawings.

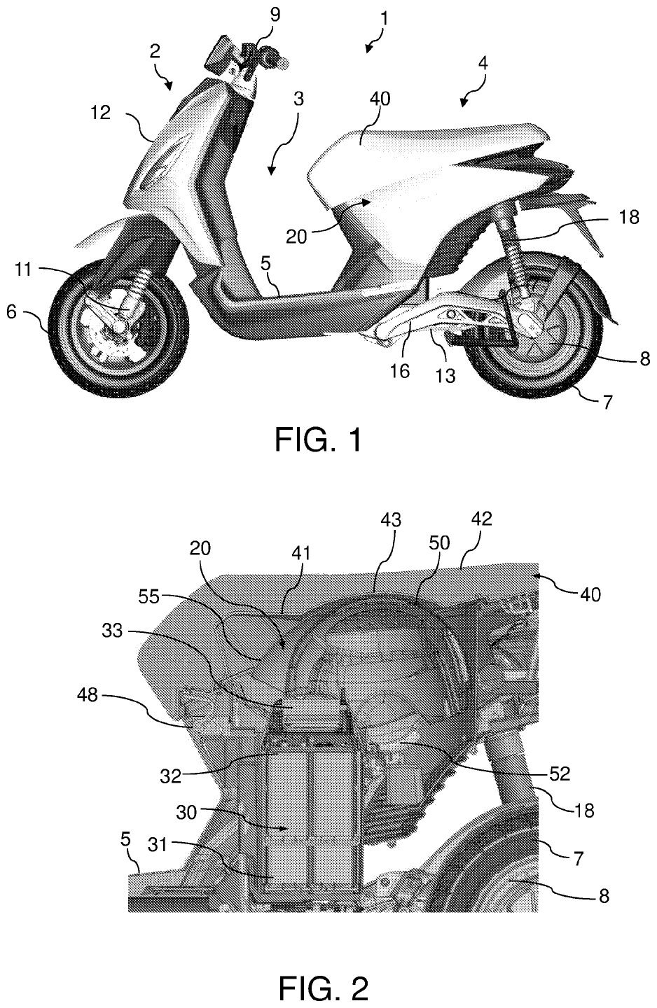

FIG. 1 shows an embodiment of an electric or hybrid rideable saddle vehicle 1 which is embodied, in the particular example shown and without however introducing any limitation, by a two-wheeled motorcycle, and in particular by a two-wheeled scooter, having a front wheel 6 and a rear wheel 7.

Hereinafter, in the present description, without however introducing any limitation, reference will be made to a general motorcycle 1, meaning that the following description can be generally applied to any type of electric or hybrid rideable saddle vehicle comprising:
a main body 2, 3, 4;
at least two wheels 6, 7 constrained to the main body 2, 3, 4;
a motor 8, in particular, an electric or hybrid traction motor operatively connected to, or integrated in, at least one of the two wheels 6, 7.

In the particular example shown in FIG. 1, the rideable saddle vehicle 1 is an electric vehicle and comprises, without however introducing any limitation, an electric motor 8 integrated in at least one of the two wheels 6, 7, in the example integrated in the rear wheel 7. In other words, in this example, the electric motor 8 is a hub motor. The assembly consisting of the rear wheel 7, and in particular of the wheel hub and the electric motor 8, is a drive wheel 7, 8.

The main body 2, 3, 4 of motorcycle 1 has a front part 2, a tail part 4, and a middle part 3 interposed between the front part 2 and the tail part 4.

The middle part 3 comprises a footboard 5, for example, on which a rider can place his/her feet.

In the example, the front part 2 comprises a front shield 12, a steering handlebar 9, the front wheel 6, a front suspension 11.

In the example, the tail part 4 comprises a rideable saddle 40, the drive wheel 7, 8, a support arm or fork 16 of the drive wheel 7, 8, a rear suspension 18.

Motorcycle 1 further comprises a storage container 20 preferably and not limitedly integrated in the main body 2, 3, 4, more preferably integrated in the tail part 4 of motorcycle 1.

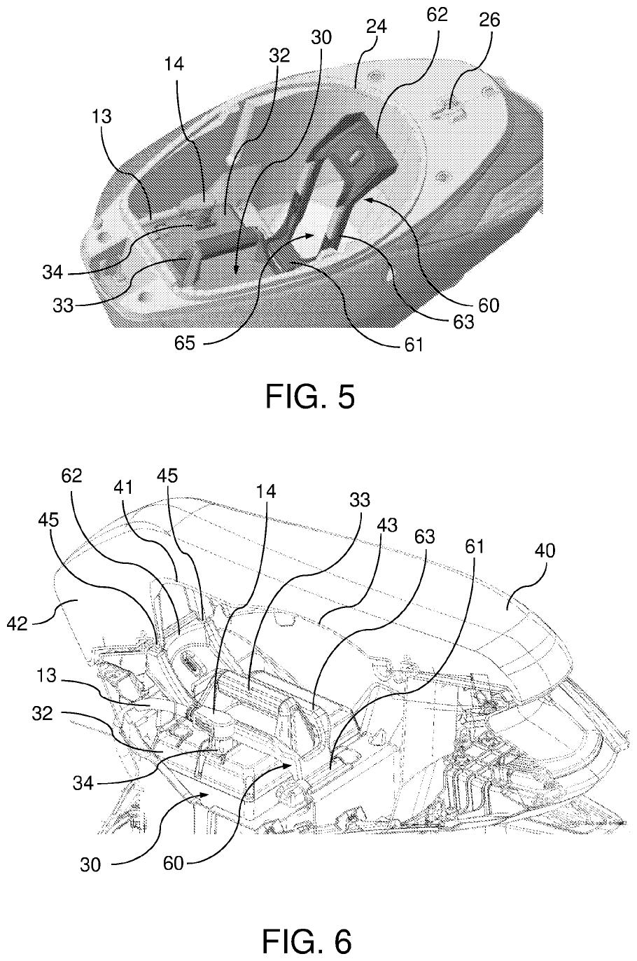

In an advantageous embodiment, the storage container 20 is arranged below the rideable saddle 40. Preferably, in this embodiment, the rideable saddle 40 can be moved between a closing configuration, in which the rideable saddle 40 prevents access to the storage container 20, and an opening configuration, in which the rideable saddle 40 allows access to the storage container 20. Therefore, in such an embodiment, the rideable saddle 40 is a closing element of the storage container 20. The rideable saddle 40, in particular in the closing configuration, reversibly obstructs an upper access opening 24 of the storage container 20. The rideable saddle 40 in FIGS. 1, 2 and 6 is shown in the closing configuration, while it is shown in the opening configuration in FIG. 4. The rideable saddle 40 was instead omitted in FIG. 5.

According to an advantageous embodiment, the rideable saddle 40 is hinged to the main body 2, 3, 4 of motorcycle 1 to be rotated between two positions angularly spaced apart from each other, corresponding to the closing configuration and to the opening configuration, respectively. In the example depicted in the drawings, motorcycle 1 comprises a cylindrical hinge 48 (FIG. 2) adapted and configured to rotatably hinge an end portion of the rideable saddle 40 to the tail portion 4 of motorcycle 1. Said end portion preferably is a front end portion of the rideable saddle 40, i.e., an end portion facing the front part 2 of the main body 2, 3, 4 of motorcycle 1.

The motorcycle 1 preferably comprises a locking system 26, 46 of the rideable saddle 40 (FIG. 4) which can be operated to take a locking configuration for locking the rideable saddle 40 in the closing configuration, and a releasing configuration to allow the rideable saddle 40 to be brought from the closing configuration to the opening configuration. The locking system 26, 46 of the rideable saddle 40 comprises, for example a lock 26 having a movable catch 27 and an engagement element 46 with which the movable catch 27 is engaged when the locking system 26, 46 is in the locking configuration. For example, lock 26 can be operated by means of a key and/or by means of a mechanical or electromechanical button and/or by means of an electrical control signal. In the particular embodiment shown for example in FIG. 4, the engagement element 46 is provided on the rideable saddle 40 and lock 26 is provided on the main body 2, 3, 4 of motorcycle 1, in particular on the tail part 4. In a constructional variant, the positions of the aforesaid elements of the locking system 26, 46 could be inverted with one another.

The motorcycle 1 further comprises at least one rechargeable battery 30, preferably an extractable rechargeable battery 30, as better shown in FIGS. 2, 3 and 4. A user may thus remove the extractable rechargeable battery 30 to be recharged and replace it with a charged extractable rechargeable battery 30, for example.

The rechargeable battery 30 is operatively connected, for example by means of an electric wire 13 (FIG. 5), to motor 8 to supply it so that it can deliver a drive torque. The rechargeable battery 30 preferably comprises an electrical connector 34 adapted to be engaged, for example by coupling, with a complementary electrical connector 14 provided at a free end of the electric wire 13.

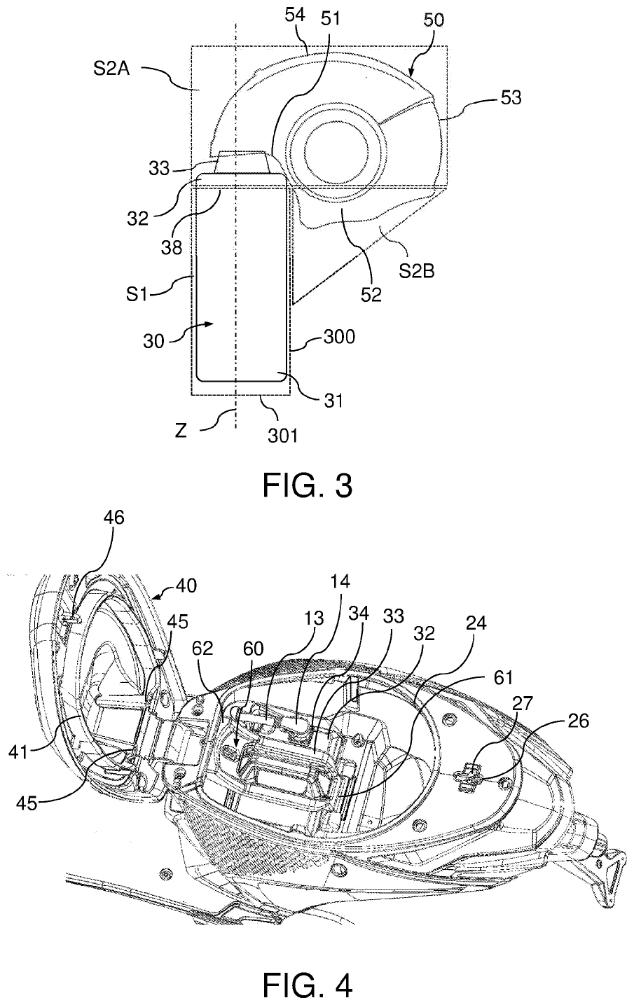

As shown in FIG. 3, the rechargeable battery 30 extends between a bottom portion 31 and a head portion 32. For example, the rechargeable battery 30 comprises a containment body made of an electrically insulating material which accommodates a plurality of rechargeable cells therein. The bottom portion 31 is a first end portion of the containment body and the head portion 32 is a second end portion of the containment body, opposite to the first end portion. For example, the containment body of the rechargeable battery 30 is prism-shaped, e.g., it has a general polygonal shape, in particular is parallelepiped-shaped, for example a straight parallelepiped.

The rechargeable battery 30 preferably comprises a gripping handle 33, preferably included in, or fixed to, the head portion 32. The gripping handle 33 preferably protrudes from the head portion 32, and more preferably is C-shaped, with two side support arms and a middle gripping part, for example for ergonomic gripping, interposed between the two side arms. For example, the two side arms are mutually inclined and the middle part is cylindrical in shape, for example.

The storage container 20 comprises a first housing seat S1 which at least partially houses the rechargeable battery 30 so that the rechargeable battery 30 can be inserted into, and extracted from, the first housing seat S1. Preferably, the rechargeable battery 30 is slidingly insertable into, and slidingly extractable from, the first housing seat S1 by translation along a sliding axis Z. In particular, the housing seat S1, with the rechargeable battery 30, substantially defines a shape coupling.

The first housing seat S1 is preferably delimited by a tubular side wall 300 and a bottom wall 301 joined to the tubular side wall 300. The first housing seat S1 preferably comprises guiding means, e.g., guides which allow directing the insertion/extraction of the rechargeable battery 30 into/from the first housing seat S1. The user is thus facilitated in placing the battery 30 in a correct position in the first housing seat S1. In detail, the first housing seat S1 and/or the rechargeable battery 30 are shaped so as to avoid the rechargeable battery 30 from being mounted in a wrong position or with a wrong orientation. In particular, the first housing seat S1 and the rechargeable battery 30 mutually form a shape coupling which defines a unique position between the first housing seat S1 and the rechargeable battery 30.

The storage container 20 further comprises a second housing seat S2A, S2B, adapted and configured to house at least one helmet 50, preferably a jet-type helmet, i.e., a helmet without a fixed chin guard.

The second housing seat S2A, S2B has a first housing portion S2A and a second housing portion S2B, which advantageously are adjacent to each other. In the present description and claims, for conciseness, the first housing portion S2A and the second housing portion S2B may be referred to by also using the terms “first portion S2A” and “second portion S2B”, respectively.

The second portion S2B is arranged below the first portion S2A and adjacent to the first housing seat S1. When the rechargeable battery 30 is inserted into the first housing seat S1, the head portion 32 of the rechargeable battery 30 partially occupies the second housing seat S2A, S2B, leaving the first portion S2A partially free and the second portion S2B totally free. The volume in the storage container 20 reserved for housing the rechargeable battery 30 thus forms a step close to which a front portion of helmet 50 can rest, e.g., an open front portion 51 of a jet helmet 50. Thereby, both a rechargeable battery 30 and a helmet 50 can be simultaneously housed in the storage container 20 even when the space onboard the motorcycle 1 reserved for the storage container 20 is relatively small.

According to a particularly advantageous embodiment, the part of the second housing seat S2A, S2B not occupied by the head portion 32 of the rechargeable battery 30 defines a space configured to house a helmet 50, preferably a jet helmet 50, which at least partially accommodates the head portion 32 therein.

With reference to the example shown in FIG. 3, when the rechargeable battery 30 is inserted into the first housing seat S1, the first housing portion S2A at least partially extends over the head portion 32 of the rechargeable battery 30 and the second housing portion S2B at least partially extends laterally with respect to the head portion 32 of the rechargeable battery 30.

According to a particularly advantageous embodiment, the head portion 32 of the rechargeable battery 30 at least partially protrudes into the second housing seat S2A, S2B, in particular into the first portion S2A. For example, if the head portion 32 of the rechargeable battery 30 comprises the gripping handle 33, when the rechargeable battery 30 is inserted into the first housing seat S1, the gripping handle 33 at least partially protrudes into the second housing seat S2A, S2B, in particular into the first portion S2A. The depth of the first housing seat S1, i.e., of the housing seat reserved for the rechargeable battery 30, can thus be reduced because, for housing the head portion 32 and/or the gripping handle 33 of the rechargeable battery 30, a relatively limited part of the housing volume of the second housing seat S2A, S2B can be utilized by utilizing the remaining part of the latter to house helmet 50. Moreover, when helmet 50 is housed in the storage container 20, the gripping handle 33 may protrude partially into the helmet 50.

According to an advantageous embodiment, the first housing seat S1 and the second housing seat S2A, S2B communicate with each other. For example, the first housing seat S1 comprises an access opening 38 which is crossable by the bottom portion 31 of the rechargeable battery 30 to insert the latter into the first housing seat S1. The first housing seat S1 and the second housing seat S2A, S2B communicate with each other through the access opening 38. For example, the access opening 38 is an opening arranged on the opposite side with respect to the bottom wall 301.

According to a particularly advantageous embodiment, the bottom portion 301 of the first housing seat S1 is arranged at a lower height with respect to the second portion S2B of the second housing seat S2A, S2B, and therefore clearly also with respect to the first portion S2A thereof.

Advantageously, the first housing seat S1 extends into the motorcycle 1 at a greater depth than the second housing seat S2A, S2B.

According to an embodiment, the storage container 20 is adapted and configured to house a jet helmet 50. As shown in FIG. 3, the jet helmet 50 comprises a shell having a front open portion 51, two opposite side portions 52, a rear portion 53, and an upper portion 54. The front open portion 51 of the shell is joined to the rear portion 53 of the shell by means of the side portions 52, while the upper portion 54 of the shell is above the front open portion 51, the side portions 52, and the rear portion 53.

Advantageously, the first portion S2A of the second housing seat S2A, S2B is adapted and configured to house the front open portion 51 of the shell. According to a particularly advantageous embodiment, the jet helmet 50 comprises at least one visor 55 (shown only in FIG. 2), and the first portion S2A of the second housing seat S2A, S2B is also adapted and configured to house the visor 55. As known per se, visor 55 is a transparent or semitransparent shield rotatably constrained to the shell and can be rotated from the outside of the shell to obstruct at least partially the front open portion 51 of the shell in a removable manner.

According to a particularly advantageous embodiment, the second portion S2B of the second housing seat S2A, S2B is adapted and configured to house at least partially the side portions 52 of the shell of the jet helmet 50.

According to an advantageous embodiment which allows increasing the useful space inside the storage container 20, the rideable saddle 40 comprises (FIG. 2) a support base 41 and a padding 42, and the support base 41 comprises a recess 43 adapted and configured to receive part of the upper portion 54 of the shell of helmet 50 when the storage container 20 accommodates a helmet 50 therein. Thereby, the first portion S2A of the second housing seat S2A, S2B advantageously partially extends into saddle 40. The aforesaid recess 43 preferably extends into the thickness of padding 42. For example, the support base 41 is a frame made of hard plastics and/or metal, and the padding is made of a yielding material, such as a spongy synthetic material. As known per se, padding 42 is covered with a waterproof coating, e.g., made of natural or synthetic leather. According to a particularly advantageous embodiment, the aforesaid recess 43 is a rounded and/or curved recess.

According to a particularly advantageous embodiment, motorcycle 1 further comprises a locking device 60 (shown in FIGS. 4-6) adapted to lock the rechargeable battery 30 in the first housing seat S1. The locking device 60 is adapted and configured to be moved in order to take an operating locking position and an operating releasing position. The locking device 60 is retained in the operating locking position by means of a thrust force applied by the rideable saddle 40 to the locking device 60 when the rideable saddle 40 takes the closing configuration. In the operating locking position shown for example in FIGS. 4 and 6, the locking device 60 prevents the rechargeable battery 30 from being removed from the first housing seat S1. Instead, in the operating releasing position shown in FIG. 5, the locking device 60 allows the removal, in particular the extraction, of the rechargeable battery 30 from the first housing seat S1, and thus from the storage container 20.

According to a particularly advantageous embodiment, the locking device 60 is accommodated in the storage container 20 and has a first end portion 61 rotatably hinged, by means of a hinge, to a wall of the storage container 20 and a second end portion 62, opposite to the first end portion 61, which is a free end portion when in the operating releasing position. In the operating locking position of the locking device 60, the rideable saddle 40 abuts against the second end portion and applies a pressure force to the latter, for example by means of at least one thrust element 45. For example, the thrust element 45 is integrated in, or fastened to, the support base 41 of the rideable saddle 40. Conveniently, the thrust element 45 protrudes from the rideable saddle 40, in particular from the support base 41, towards the storage container 20, preferably so as to cross the upper access opening 24.

The locking device 60 preferably comprises at least one locking arm 63 which extends between the first end portion 61 and the second end portion 62. In the operating locking position, the at least one locking arm 63 applies a thrust force to the rechargeable battery 30, in particular to the head portion 32. The rechargeable battery 30 is thus kept in a stable position inside the first housing seat S1 and possible vibrations, noise, and jolts of the rechargeable battery 30 when using, for example when driving, the motorcycle 1 are eliminated. According to an advantageous and non-limiting embodiment, the locking device 60 comprises two locking arms 63 which are joined to each other on one side by the first end portion 61 and on another side by the second end portion 62.

According to a particularly advantageous embodiment, the locking device 60 comprises at least one recess or a through opening 65 (FIG. 5) which accommodates, or is crossed by, a protruding part of the rechargeable battery 30 in the operating locking position of the locking device 60. Such a protruding part preferably is the gripping handle 33. For example, the aforesaid recess or through opening 65 extends into the locking arm 63 or between the locking arms 63.

Based on the explanation above, it is thus possible to understand how an electric or hybrid rideable saddle vehicle 1 of the type described above allows achieving the purposes indicated above with reference to the prior art.

Without prejudice to the principle of the invention, the embodiments and the manufacturing details can be broadly varied with respect to the above description disclosed by way of a non-limiting example, without departing from the scope of the invention as defined in the appended claims.

1. An electric or hybrid rideable saddle vehicle, comprising:
a rechargeable battery which extends between a bottom portion and a head portion;
an electric or hybrid traction motor which can be supplied by the rechargeable battery to deliver a traction torque;
a storage container;
wherein the storage container comprises:
a first housing seat which at least partially houses the rechargeable battery so that the rechargeable battery can be inserted into, and extracted from, the first housing seat;
a second housing seat, adapted and configured to house at least one helmet, having a first portion and a second portion;
wherein:
the second portion is arranged below the first portion and adjacent to the first housing seat;
when the rechargeable battery is inserted into the first housing seat, the head portion of the rechargeable battery partially occupies the second housing seat, leaving the first portion partially free and the second portion totally free.

2. The electric or hybrid rideable saddle vehicle according to claim 1, wherein a part of the second housing seat not occupied by the head portion of the rechargeable battery defines a space configured to house said helmet, which at least partially accommodates the head portion therein.

3. The electric or hybrid rideable saddle vehicle according to claim 1, wherein the head portion of the rechargeable battery at least partially protrudes into the second housing seat.

4. The electric or hybrid rideable saddle vehicle according to claim 3, wherein the head portion comprises a gripping handle, and wherein when the rechargeable battery is inserted into the first housing seat, the gripping handle at least partially protrudes into the second housing seat.

5. The electric or hybrid rideable saddle vehicle according to claim 1, wherein the first housing seat and the second housing seat communicate with each other.

6. The electric or hybrid rideable saddle vehicle according to claim 5, wherein the first housing seat comprises an access opening which is crossable by the bottom portion to insert the rechargeable battery into the first housing seat, and wherein the first housing seat and the second housing seat communicate with each other through the access opening.

7. The electric or hybrid rideable saddle vehicle according to claim 1, wherein the rechargeable battery is slidingly insertable into, and extractable from, the first housing seat by translation along a sliding axis.

8. The electric or hybrid rideable saddle vehicle according to claim 1, wherein:
the helmet is a jet helmet comprising a shell having a front open portion, two mutually opposite side portions, a rear portion, and an upper portion, wherein the front open portion is joined to the rear portion by means of the side portions, and wherein the upper portion is above the front open portion, the side portions, and the rear portion;
the first portion of the second housing seat is adapted and configured to accommodate the front open portion of the shell.

9. The electric or hybrid rideable saddle vehicle according to claim 8, wherein the second portion of the second housing seat is adapted and configured to accommodate at least partially the side portions of the shell.

10. The electric or hybrid rideable saddle vehicle according to claim 8, further comprising a rideable saddle, and wherein:
the storage container is placed below the rideable saddle;
the rideable saddle can be moved between a closing configuration, in which the rideable saddle prevents access to the storage container, and an opening configuration, in which the rideable saddle allows access to the storage container.

11. The electric or hybrid rideable saddle vehicle according to claim 10 comprising a main body, and wherein the rideable saddle is hinged to the main body to be rotated between two angular positions corresponding to the closing configuration and the opening configuration, respectively.

12. The electric or hybrid rideable saddle vehicle according to claim 10, wherein the rideable saddle comprises a support base and a padding, and wherein the support base comprises a recess adapted and configured to receive partially said upper portion of the shell of the helmet.

13. The electric or hybrid rideable saddle vehicle according to claim 12, wherein said recess is rounded and/or curved.

14. The electric or hybrid rideable saddle vehicle according to claim 10, comprising a locking device adapted to lock the rechargeable battery in the first housing seat, wherein the locking device is adapted and configured to be moved to take an operating locking position and an operating releasing position and wherein the locking device is retained in the operating locking position by means of a thrust force applied by the rideable saddle when the rideable saddle takes the closing configuration.

15. The electric or hybrid rideable saddle vehicle according to claim 14, wherein the locking device is housed in the storage container and has a first end portion rotatably hinged to a wall of the storage container.

16. The electric or hybrid rideable saddle vehicle according to claim 1, wherein the first housing seat has a bottom portion arranged at a lower height with respect to the second portion of the second housing seat.

17. The electric or hybrid rideable saddle vehicle according to claim 1, wherein the first housing seat extends into the vehicle at a greater depth than the second housing seat.

18. A group of parts comprising an electric or hybrid rideable saddle vehicle according to claim 1 and a helmet which can be housed in the second housing seat of the storage container.
